(19) United States
(12) Patent Application Publication
(10) Pub. No.: US 2023/0030476 A1
(43) Pub. Date: Feb. 2, 2023

(54) CONTROL DEVICE FOR INDUSTRIAL MACHINE

(71) Applicant: FANUC CORPORATION, Minamitsuru-gun, Yamanashi (JP)

(72) Inventor: Kouji SEKIMOTO, Yamanashi (JP)

(21) Appl. No.: 17/789,603

(22) PCT Filed: Jan. 18, 2021
(86) PCT No.: PCT/JP2021/001483

§ 371 Date: Jun. 28, 2022

(30) Foreign Application Priority Data
Jan. 22, 2020 (JP) 2020-008299

(51) Int. Cl. G05B 19/4155

(52) U.S. Cl. CPC G05B 19/4155; G05B 2219/31449

(57) ABSTRACT

A number of communications for transmitting update data from a control device to a client is decreased, and discrepancies in the content of the latest update data between the control device and the client are prevented. The control device has: an update data monitoring unit for monitoring the latest update data and monitoring whether there has been an update within a predetermined time thereafter; an update data confirmation unit which, if there has been no update in the predetermined time, transmits to the client a request to confirm an update data reception state; a reception state determination unit which, based on the update data reception state in the client and the latest update data, determines whether the client has received the latest update data; and a retransmission instructing unit which, if the client has not received the latest update data, re-transmits the latest update data to the client.

### TECHNICAL FIELD

The present invention relates to a control device for an industrial machine.

### BACKGROUND ART

A control device configured to control an industrial machine, such as a machine tool, an industrial machine, or a robot, is provided with a server configured to communicate in an interactive manner with a client, such as a display or a tablet. In the control device, predetermined delivery-target data is delivered to the client. Furthermore, for example, to decrease the number of communications between the server and the client when there is an update on the server side, such a push generally takes place between the server and the client to transmit the update data to the client (e.g., see Japanese Unexamined Patent Application, Publication No. 2003-134566). It is possible to apply such a technology to communications between a client and a server included in a control device.

However, if the client side fails to receive the updated data that has been push-transmitted from the server side due to a communication failure, for example, and, when a new update occurs thereafter on the control device side, such a situation occurs that there are discrepancies between the data retained on the client side and the data retained on the server side, before the update data is to be push-transmitted to the client side. FIG. 3A is a view illustrating an example when a numerical control device serving as a control device causes a feed shaft of a machine tool that is in operation to move from X100 to X500, and when the coordinate value is push-transmitted to the client side. As illustrated in FIG. 3A, for example, when the client side has failed to receive the coordinate value of X500, such a phenomenon occurs whereby the client side retains a previous coordinate value, i.e., a coordinate value of X499, even though the numerical control device side (the server side) retains the latest coordinate value of X500.

In this respect, in a common practice, when data is transmitted from a server to a client, and the client has received the data, the client returns, to the server, a response regarding the fact that the client has received the data. FIG. 3B is a view illustrating an example when the numerical control device serving as the control device causes the feed shaft of the machine tool that is in operation to move from X100 to X500, and when the coordinate value is push-transmitted to the client side, and the client side returns, to the numerical control device side (the server side), each time the client has received the data, a response regarding the fact that the client has received the data. As illustrated in FIG. 3B, when data has been transmitted (pushed) from the numerical control device side (the server side) to the client side, and when the client side has not yet received the coordinate value of X500 due to a communication failure, for example, the coordinate value of X500 will be retransmitted from the numerical control device side (the server side) to the client side after a predetermined period of time has passed.

In such a case, when data, such as a coordinate value in a machine tool that is in operation, which is to be push-transmitted from the numerical control device side (the server side) to the client side, is frequently updated, for example, additional communications occur due to the client side transmitting a response each time the client side has received the data. This situation conflicts with the original object of decreasing the number of communications between the server and the client.
Patent Document 1: Japanese Unexamined Patent Application, Publication No. 2003-134566

### DISCLOSURE OF THE INVENTION

### Problems to be Solved by the Invention

Furthermore, even when data is excessively frequently updated on the numerical control device side (the server side), and even when the client side fails to receive some pieces of update data, some cases may not be problematic. Returning a response to the numerical control device side (the server side) each time the client side has received the data, and confirming such a response each time it is received on the numerical control device side (the server side) are thus regarded as redundant.

Therefore, what is desired is, while interactive communications are used between a client side and a control device configured to control an industrial machine to transmit update data from the control device to the client, to decrease the number of communications, and to ensure that there are no discrepancies in the content of the data between the control device and the client side.

### Means for Solving the Problems

(1) A control device according to an aspect of the present disclosure represents a control device for an industrial machine. The control device is configured to transmit, each time predetermined transmission-target data is updated, the update data to a client being communicably coupled. The control device includes: an update data storage unit configured to store the update data; a data transmission unit configured to transmit the update data to the client; an update data monitoring unit configured to monitor the update data, the update data being latest, the update data being stored in the update data storage unit, to monitor whether the update data being latest has been subsequently updated within a predetermined first period of time; an update data confirmation unit configured to transmit, when the update data monitoring unit has detected that the update data being latest has not yet been updated within the first period of time, a request to confirm a reception state regarding the transmission-target data to the client; a reception state determination unit configured to determine, based on the reception state regarding the transmission-target data that the update data confirmation unit has received from the client and the update data being latest and stored in the update data storage unit, whether the client has received the update data being latest; and a retransmission instruction unit configured to retransmit, when the reception state determination unit has determined that the client has not yet received the update data being latest, the latest update data to the client.

### Effects of the Invention

According to the aspect, it is possible, while interactive communications are used between a client side and a control device configured to control an industrial machine to transmit update data from the control device to the client, to decrease the number of communications, and to ensure that there are no discrepancies in the content of the data between the control device and the client side.

### BRIEF DESCRIPTION OF THE DRAWINGS

FIG. 1 is an operational block diagram illustrating a functional configuration example of a control device according to an embodiment;

FIG. 2A is a flowchart illustrating control processing performed by the control device;

FIG. 2B is a flowchart illustrating the control processing performed by the control device;

FIG. 3A is a view illustrating an example when a numerical control device push-transmits coordinate value data in a machine tool that is in operation to a client each time the coordinate value data is updated; and

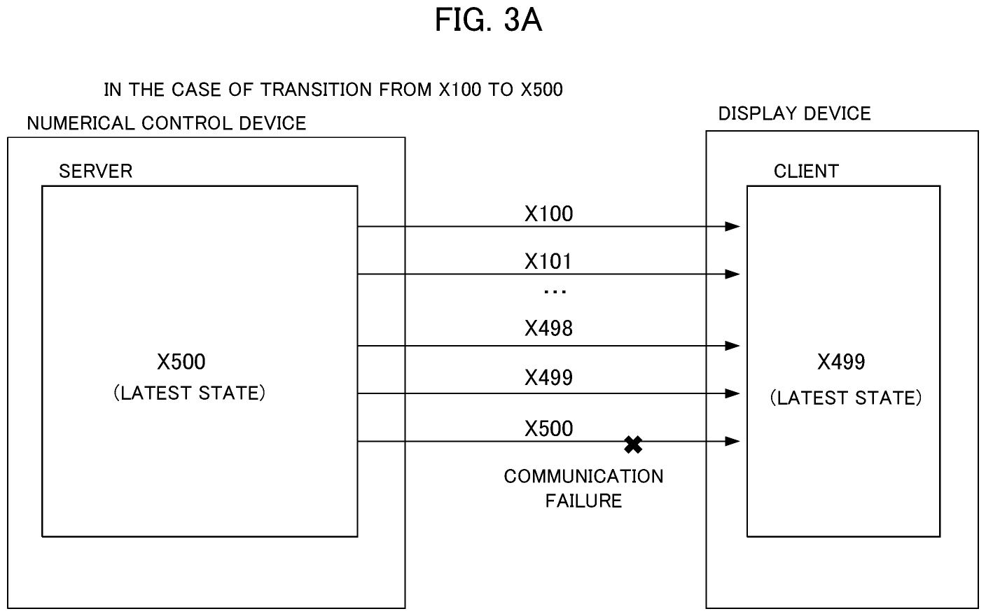

FIG. 3B is a view illustrating an example when the numerical control device push-transmits coordinate value data in the machine tool that is in operation to the client each time the coordinate value data is updated, and the client provides a response regarding reception to the numerical control device each time the coordinate value data is received.

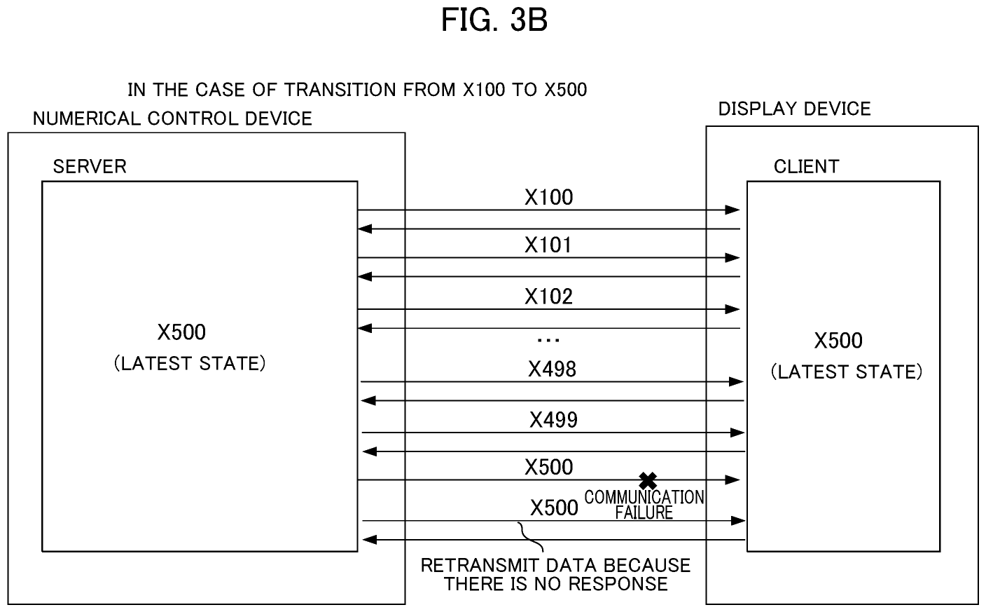

### PREFERRED MODE FOR CARRYING OUT THE INVENTION

An embodiment of the present disclosure will now be described herein with reference to the accompanying drawings. In the below description, a machine tool is exemplified as an industrial machine, and a numerical control device is exemplified as a control device. Note that the present invention is not limited to such machine tools, but is applicable to, for example, industrial robots and servicing robots.

### EMBODIMENT

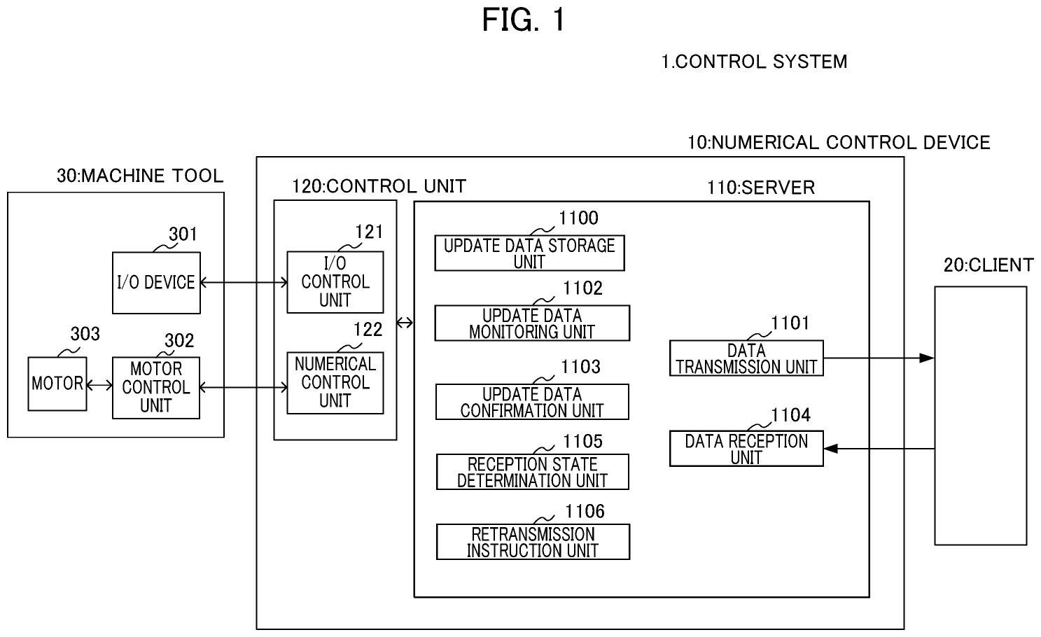

FIG. 1 is an operational block diagram illustrating a functional configuration example of a control system according to an embodiment. As illustrated in FIG. 1, a control system 1 includes a numerical control device 10 serving as a control device, a client 20, and a machine tool 30 serving as an industrial machine.

The numerical control device 10, the client 20, and the machine tool 30 may be directly coupled to each other via a coupling interface that is not shown. Furthermore, the numerical control device 10, the client 20, and the machine tool 30 may be coupled to each other via a network that is not shown, such as a local area network (LAN) or the Internet. The numerical control device 10 and the client 20 each include a communication unit configured to perform intercommunications.

The client 20 represents, for example, a portable terminal having a display, a tablet, or a personal computer (PC). The client 20 is configured to receive an input such as a processing request from a user via an input device (not shown) such as a keyboard or a touch panel that the client 20 includes, and to transmit the received input to the numerical control device 10 described later. Furthermore, the client 20 is configured to receive an output from the numerical control device 10, and to cause an output device (not shown) such as a liquid crystal display included in the client 20 to display the received output.

The machine tool 30 represents a machine tool known to those skilled in the art, includes, for example, as illustrated in FIG. 1, an input-and-output (I/O) device 301, a motor control unit 302, and a motor 303, and is configured to operate based on an operation instruction provided from the numerical control device 10 serving as the control device.

### <Numerical Control Device 10>

The numerical control device 10 represents a numerical control device known to those skilled in the art, and is configured to generate an operation instruction based on a processing request provided from the client 20 and a machining program acquired from an external device (not shown) such as devices for computer aided designing (CAD)/computer aided manufacturing (CAM), and to transmit the generated operation instruction to the machine tool 30. Thereby, the numerical control device 10 controls operation of the machine tool 30. Note that, when the machine tool 30 is a robot, for example, the numerical control device 10 may be a robot control device, for example.

As illustrated in FIG. 1, the numerical control device 10 includes a server 110 and a control unit 120. Furthermore, the control unit 120 includes an I/O control unit 121 and a numerical control unit 122 both representing an ordinary configuration for executing numerical control processing.

### <Server 110>

The server 110 represents, for example, a Web server, and is configured to perform interactive communications with the client 20 via a network 50. The server 110 is configured to transmit, each time the control unit 120 has updated transmission-target data that has been predetermined to the client 20, the update data to the client 20. The server 110 includes an update data storage unit 1100, a data transmission unit 1101, an update data monitoring unit 1102, an update data confirmation unit 1103, a data reception unit 1104, a reception state determination unit 1105, and a retransmission instruction unit 1106.

The update data storage unit 1100 represents, for example, a desired storage, such as a random access memory (RAM) or a hard disk drive (HDD). Each time the control unit 120 updates transmission-target data that has been predetermined to the client 20, the update data is stored. Note that the update data storage unit 1100 stores the update data together with a time stamp. Note herein that the time stamp may represent, for example, a time when the update data storage unit 1100 has stored the update data. Furthermore, the time stamp may represent, for example, a time when the control unit 120 has updated the update data. Storing the update data together with a time stamp allows, as will be described later, the update data monitoring unit 1102 to monitor the latest update data stored in the update data storage unit 1100 to monitor whether the latest update data has been subsequently updated within a predetermined first period of time. Furthermore, the update data storage unit 1100 may store the update data together with a control number for the update data. Note herein that, for example, the control number may be transmitted to the client 20 together with the update data. Thereby, as will be described later, the reception state determination unit 1105 is able to determine, based on the control number, whether the client 20 has received the latest update data.

The data transmission unit 1101 is configured to transmit, each time predetermined transmission-target data is updated, the update data to the client 20. Furthermore, the data transmission unit 1101 is configured to transmit, based on an instruction provided from the update data confirmation unit 1103 described later, to the client 20, a request to confirm a reception state regarding the transmission-target data.

The update data monitoring unit 1102 is configured to monitor, each time the predetermined transmission-target data is updated, whether the update data has been subsequently updated to the new update data within a predetermined first period of time. Specifically, for example, the update data monitoring unit 1102 is configured to monitor the latest update data stored in the update data storage unit 1100 to monitor whether the latest update data has been subsequently updated to the new update data within the first period of time. With the update data stored together with the time stamp, the update data monitoring unit 1102 may compare the time stamp with a current time of an internal timepiece (not shown) to monitor whether the latest update data stored in the update data storage unit 1100 has been subsequently updated to the new update data within the first period of time. Furthermore, the update data monitoring unit 1102 may be configured to monitor the latest update data stored in the update data storage unit 1100 per predetermined constant period to monitor whether the update data has been updated within the predetermined number of periods. In this case, a value acquired from a calculation of period multiplied by number of periods corresponds to the first period of time described above.

The update data confirmation unit 1103 is configured to transmit, when the update data monitoring unit 1102 has detected that the latest update data has not yet been subsequently updated within the first period of time, a request to confirm a reception state regarding the transmission-target data to the client 20 via the data transmission unit 1101. Note that the update data confirmation unit 1103 may be configured to not ask the client, when a retransmission flag (not shown) described later has been turned to on, even when it has been detected that the latest update data has not yet been subsequently updated within the first period of time, to confirm the reception state regarding the transmission-target data in the client 20. Note herein that the state where the retransmission flag has been turned to on represents that the latest update data has already been retransmitted to the client 20.

The data reception unit 1104 is configured to receive data transmitted from the client 20 to the server 110. For example, the data reception unit 1104 is configured to receive, from the client 20, a response (i.e., the reception state regarding the transmission-target data in the client 20) to the request to confirm the reception state regarding the transmission-target data. Note that the data reception unit 1104 may be configured to further receive desired data that the client 20 transmits.

The reception state determination unit 1105 is configured to determine, based on the reception state regarding the transmission-target data in the client 20, which has been received from the client 20, and the latest update data stored in the update data storage unit 1100, whether the client 20 has received the latest update data. Specifically, the client 20 may transmit, as the reception state regarding the transmission-target data, the last-received update data. Thereby, the reception state determination unit 1105 is able to compare the update data that the update data confirmation unit 1103 has received from the client 20 with the latest update data stored in the update data storage unit 1100 to determine whether the client 20 has received the latest update data. Furthermore, as described above, the client 20 may transmit, instead of the last-received update data, the control number of the update data. Thereby, the reception state determination unit 1105 is able to compare the control number of the latest update data that the update data confirmation unit 1103 has received from the client 20 with the control number regarding the latest update data stored in the update data storage unit 1100 to determine whether the client 20 has received the latest update data. Note that the reception state determination unit 1105 may turn the retransmission flag (not shown) described above to on when it has been determined that the client 20 has received the latest update data. Thereby, as described above, the update data confirmation unit 1103 is able to not ask the client, when the retransmission flag regarding the update data has been turned to on, even when it has been detected that the latest update data has not yet been subsequently updated within the first period of time, to confirm the reception state regarding the transmission-target data.

The retransmission instruction unit 1106 is configured to perform control of retransmitting, when the reception state determination unit 1105 has determined that the client 20 has not yet received the latest update data, the latest update data to the client 20. Specifically, the retransmission instruction unit 1106 is configured to transmit the latest update data to the client 20 via the data transmission unit 1101. Furthermore, the retransmission instruction unit 1106 is configured to turn on the retransmission flag indicating that the latest update data has been retransmitted to the update data storage unit 1100. Turning the retransmission flag to on allows, as described above, the update data confirmation unit 1103 to not ask the client 20, even when it has been detected that the latest update data has not yet been subsequently updated within the first period of time, to confirm the reception state regarding the transmission-target data.

As described above, it is possible, while interactive communications are used between the numerical control device 10 and the client 20 to transmit update data from the numerical control device 10 to the client 20, to decrease the number of communications, and to ensure that there are no discrepancies in the content of the data between the numerical control device 10 and the client 20.

### <Delivery Processing Regarding Update Data for Server 110>

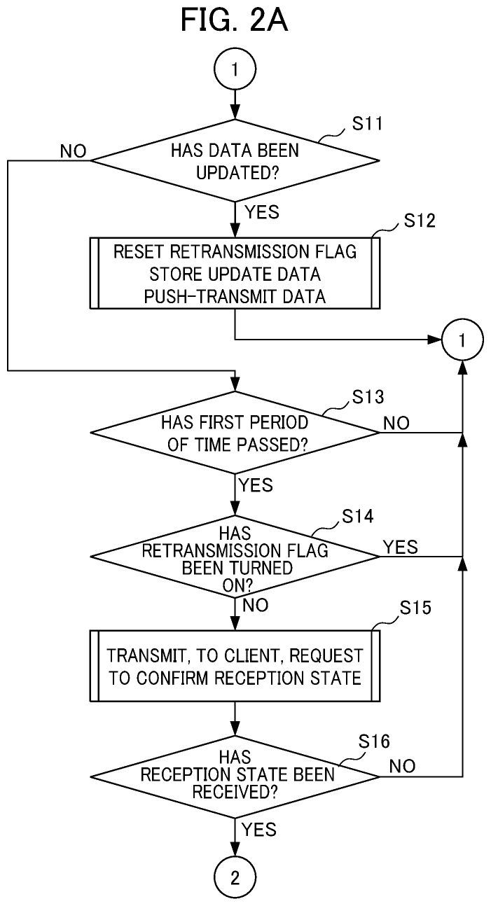

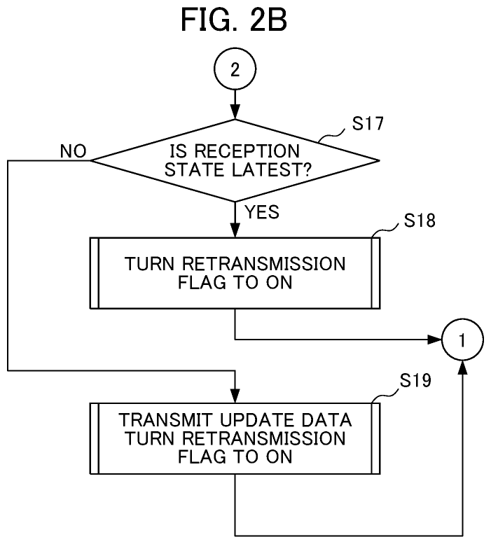

Next, operation (processing for ensuring the latest data state in the client) regarding the server 110 of the numerical control device 10 according to the present embodiment will now be described herein. FIGS. 2A and 2B are flowcharts illustrating the operation (the processing for ensuring the latest data state in the client) regarding the server 110 of the numerical control device 10.

The processing flow illustrated in FIGS. 2A and 2B represents a processing flow of the operation (the processing for ensuring the latest data state in the client) regarding the server 110 when the numerical control device 10 push-transmits data representing predetermined transmission-target data, which has been updated, to the client 20. Therefore, before starting the processing flow, there is a step for starting the processing for push-transmitting update data, and, after the processing flow, there is a step for ending the processing for push-transmitting the update data.

With reference to FIG. 2A, it is determined, in Step S11, whether the predetermined transmission-target data has been updated. When it has been determined that the data has been updated (in the case of YES), the flow proceeds to Step S12. When it has been determined that the data has not yet been updated (in the case of NO), the flow proceeds to Step S13.

In Step S12, the retransmission flag is reset, the update data is stored in the update data storage unit 1100, and the update data is push-transmitted to the client 20. After that, the flow proceeds to Step S11.

In Step S13, the update data monitoring unit 1102 determines whether the first period of time has passed after the latest update data stored in the update data storage unit 1100 has been updated. When it has been determined that the first period of time has passed (in the case of YES), the flow proceeds to Step S14. When it has been determined that the first period of time has not yet passed (in the case of NO), the flow proceeds to Step S11.

In Step S14, the update data confirmation unit 1103 determines whether the retransmission flag has been turned to on. When it has been determined that the retransmission flag has been turned to on (in the case of YES), the flow proceeds to Step S11. The new update data is transmitted to the client 20 via the data transmission unit 1101. After that, the flow proceeds to Step S11.

In Step S14, the update data confirmation unit 1103 determines whether the retransmission flag for the update data has been turned to on. When it has been determined that the retransmission flag for the update data has been turned to on (in the case of Yes), the flow proceeds to Step S11. When it has been determined that the retransmission flag for the update data has been kept off (in the case of No), the flow proceeds to Step S15.

In Step S15, the update data confirmation unit 1103 transmits a request to confirm the reception state regarding the transmission-target data in the client to the client 20 via the data transmission unit 1101.

In Step S16, the update data confirmation unit 1103 determines whether the reception state regarding the transmission-target data in the client has been received from the client 20. When it has been determined that the reception state has been received (in the case of Yes), the flow proceeds to Step S17. When it has been determined that the reception state has not yet been received (in the case of No) due to timeout, for example, the flow proceeds to Step S11.

With reference to FIG. 2B, in Step S17, the reception state determination unit 1105 determines, based on the reception state regarding the transmission-target data in the client 20 and the latest update data stored in the update data storage unit 1100, whether the reception state in the client 20 is the latest. When it has been determined that the state is the latest (in the case of Yes), the flow proceeds to Step S18. When it has been determined that the state is not the latest (in the case of No), the flow proceeds to Step S19.

In Step S18, the reception state determination unit 1105 turns the retransmission flag to on. After that, the flow proceeds to Step S11.

In Step S19, the retransmission instruction unit 1106 transmits the latest update data to the client 20 via the data transmission unit 1101, and turns the retransmission flag to on. After that, the flow proceeds to Step S11.

As described above, the numerical control device 10 serving as the control device according to the embodiment makes it possible to ensure that there are no discrepancies in the content of data between the numerical control device 10 (the server 110) and the client 20. Although the example of the processing flow has been described above, the present invention is not limited to the processing flow described above. For example, in Step S11, it may be determined whether predetermined transmission-target data is updated at per predetermined constant period. Furthermore, in Step S16, if the reception state regarding the transmission-target data in the client 20 cannot be received from the client 20, due to timeout, for example, (in the case of No), the flow may return to Step S15 to retransmit a request to confirm the reception state regarding the transmission-target data in the client. Note that, if a response from the client 20 is not received even if retransmission of a request to confirm the reception state regarding the transmission-target data in the client has been repeated a predetermined number of times, an error may be notified, and the flow may proceed to Step S11. Furthermore, when the latest update data is sent to the client 20 via the data transmission unit 1101 in step S19, the retransmission flag may be turned on when client 20 receives a response indicating that it has received the update data.

Although the embodiment has been described above, the numerical control device 10 and the server 110 are not limited to those described in the above embodiment, but include modifications and improvements that fall within the scope of the present invention, as long as it is possible to achieve the object of the present invention.

### Modification Example 1

Although the embodiment described above has exemplified the numerical control device 10 as the control device and the machine tool 30 as the industrial machine, the present invention is not limited thereto. For example, when a robot is used as an industrial machine, a robot control device (not shown) serving as the control device may include a server, and may be configured to transmit, each time transmission-target data that has been predetermined to the client 20 is updated, the update data to the client 20. As transmission-target data, for example, “coordinate values of robot parts”, “motor information of robot parts”, and other information may be set.

Note that it is possible to achieve each of functions included in the numerical control device 10 according to the embodiment through hardware, software, or a combination thereof. Note herein that, when a function is achieved through hardware, it means that, for example, the function is achieved through an electronic circuit. Furthermore, when a function is achieved through software, it means that the function is achieved when a computer reads and executes a program.

It is possible to use a non-transitory computer readable medium that varies in type to store the programs, and to supply the programs to a computer. Examples of the non-transitory computer readable medium include tangible storage media that vary in type. Examples of the non-transitory computer readable medium include magnetic recording media (e.g., flexible disks, electromagnetic tape, and hard disk drives), magneto-optical recording media (e.g., magneto-optical discs), compact disc read only memories (CD-ROMs), compact disc-recordables (CD-Rs), compact disc-rewritables (CD-R/Ws), semiconductor memories (e.g., mask ROMs, programmable ROMs (PROMs), erasable PROMs (EPROMs), flash ROMs, and random access memories (RAMs)). Furthermore, the programs may be supplied to the computer via a transitory computer readable medium that varies in type. Examples of the transitory computer readable medium include electric signals, optical signals, and electromagnetic waves. A transitory computer readable medium is able to supply the programs to the computer via wired communication channels such as electric wires and optical fibers or wireless communication channels.

Note that steps for describing programs to be recorded in a recording medium include not only processes sequentially executed in a chronological order, but also processes that may not necessarily be executed in a chronological order, but may be executed in parallel or separately.

In other words, it is possible that the control device and the control method according to the present disclosure take various types of embodiments having configurations described below.

(1) The numerical control device 10 serving as the control device according to the present disclosure represents a control device for the machine tool 30 serving as an industrial machine. The control device is configured to transmit, each time predetermined transmission-target data is updated, the update data to the client 20 being communicably coupled. The control device includes: the update data storage unit 1100 configured to store the update data; the update data monitoring unit 1102 configured to monitor the latest update data stored in the update data storage unit 1100 to monitor whether the latest update data has been subsequently updated within a predetermined first period of time; the update data confirmation unit 1103 configured to transmit, when the update data monitoring unit 1102 has detected that the latest update data has not yet been updated within the first period of time, to the client 20, a request to confirm a reception state regarding the transmission-target data; the reception state determination unit 1105 configured to determine, based on the reception state regarding the transmission-target data that the update data confirmation unit 1103 has received from the client 20 and the latest update data stored in the update data storage unit 1100, whether the client 20 has received the latest update data; and the retransmission instruction unit 1106 configured to retransmit, when the reception state determination unit 1105 has determined that the client 20 has not yet received the latest update data, the latest update data to the client 20. With the numerical control device 10 serving as the control device, it is possible, while interactive communications are used between the numerical control device 10 and the client 20 to transmit update data from the numerical control device 10 to the client 20, to decrease the number of communications, and to ensure that there are no discrepancies in the content of the data between the numerical control device 10 and the client 20.

(2) In the numerical control device 10 serving as the control device, as described in (1), the update data storage unit 1100 may be caused to store, together with the update data, a time when the update data has been stored and/or an update time when the update data has been updated. Thereby, comparing the time stored, together with the update data, in the update data storage unit 1100 with the current time of the internal timepiece (not shown) makes it possible to easily monitor whether the latest update data stored in the update data storage unit 1100 has been subsequently updated within the predetermined first period of time.

(3) In the numerical control device 10 serving as the control device, as described in (1) or (2), the retransmission instruction unit 1106 may cause the update data storage unit 1100 to store the retransmission flag indicating that the latest update data has been retransmitted. Thereby, the update data confirmation unit 1103 is able to not ask the client, when the retransmission flag regarding the update data has been turned to on, even when it has been detected that the latest update data has not yet been subsequently updated within the predetermined first period of time, to confirm the reception state regarding the transmission-target data.

(4) The numerical control device 10 serving as the control device, as described in any one of (1) to (3), may include the server 110 configured to communicate with the client 20. The server 110 may include the update data storage unit 1100, the update data monitoring unit 1102, the update data confirmation unit 1103, the reception state determination unit 1105, and the retransmission instruction unit 1106. Thereby, it is possible to achieve the effects described in (1).

(5) In the control device as described in any one of (1) to (4), the industrial machine may represent an industrial robot, and the control device may represent a robot control device. Thereby, even in a case where the control device represents a robot control device, and the industrial machine represents an industrial robot, it is possible to achieve the effects described in (1) to (4).

### EXPLANATION OF REFERENCE NUMERALS

1 CONTROL SYSTEM
10 NUMERICAL CONTROL DEVICE
110 SERVER
1100 UPDATE DATA STORAGE UNIT
1101 DATA TRANSMISSION UNIT
1102 UPDATE DATA MONITORING UNIT
1103 UPDATE DATA CONFIRMATION UNIT
1104 DATA RECEPTION UNIT
1105 RECEPTION STATE DETERMINATION UNIT
1106 RETRANSMISSION INSTRUCTION UNIT
120 CONTROL UNIT
121 I/O CONTROL UNIT
122 NUMERICAL CONTROL UNIT
20 CLIENT
30 MACHINE TOOL
301 I/O DEVICE
302 MOTOR CONTROL UNIT
303 MOTOR
50 NETWORK

1. A control device for an industrial machine, the control device being configured to transmit, each time predetermined transmission-target data is updated, the update data to a client being communicably coupled, the control device comprising:
an update data storage unit configured to store the update data;
a data transmission unit configured to transmit the update data to the client;
an update data monitoring unit configured to monitor the update data, the update data being latest, the update data being stored in the update data storage unit, to monitor whether the update data being latest has been subsequently updated within a predetermined first period of time;
an update data confirmation unit configured to transmit, when the update data monitoring unit has detected that the update data being latest has not yet been updated within the first period of time, a request to confirm a reception state regarding the transmission-target data to the client;
a reception state determination unit configured to determine, based on the reception state regarding the transmission-target data that the update data confirmation unit has received from the client and the update data being latest and stored in the update data storage unit, whether the client has received the update data being latest; and
a retransmission instruction unit configured to retransmit, when the reception state determination unit has determined that the client has not yet received the update data being latest, the latest update data to the client.

2. The control device according to claim 1, wherein the update data storage unit stores,
together with the update data, a time when the update data has been stored and/or an update time when the update data has been updated.

3. The control device according to claim 1, wherein the retransmission instruction unit stores a retransmission flag indicating that the update data being latest has been retransmitted to the update data storage unit.

4. The control device according to claim 1,
wherein the control device includes
a server configured to communicate with the client,
the server including
the update data storage unit,
the update data monitoring unit,
the update data confirmation unit,
the reception state determination unit, and
the retransmission instruction unit.

5. The control device according to claim 1, wherein the industrial machine represents a machine tool, and the control device represents a numerical control device.

6. The control device according to claim 1, wherein the industrial machine represents an industrial robot, and the control device represents a robot control device.
